(19) United States
(12) Patent Application Publication
(10) Pub. No.: US 2007/0286083 A1
(43) Pub. Date: Dec. 13, 2007

(54) Methods, systems and computer program products for individually identifying and disabling circular routes from a plurality of active routes to a common destination

(75) Inventors: John L. Hildebrand, Hillsborough, NC (US); Komal G. Khungar, Morrisville, NC (US); Peter J. Marsico, Chapel Hill, NC (US)

Correspondence Address: JENKINS, WILSON, TAYLOR & HUNT, P. A., 3100 TOWER BLVD., Suite 1200, DURHAM, NC, 27707, US

(73) Assignee: Tekelec

(21) Appl. No.: 11/510,120

(22) Filed: Aug. 25, 2006

Related U.S. Application Data
(60) Provisional application No. 60/812,375, filed on Jun. 9, 2006.

(51) Int. Cl. H04J 3/14; H04J 1/16

(52) U.S. Cl. 370/238; 370/252

(57) ABSTRACT

Methods, systems, and computer program products for individually identifying and disabling circular routes from active routes to a common destination are disclosed. According to one method, multiple active routes are maintained to a common destination. Congestion is detected on a signaling link associated with at least one of the routes. In response to detecting the congestion, at least one of the routes is tested for circularity. One of the routes is identified as circular based on the testing. In response to identifying the route as circular, the route is disabled and use of the remaining active routes to the destination is continued.

### RELATED APPLICATIONS

This application claims the benefit of U.S. Provisional Patent Application Ser. No. 60/812,375, filed Jun. 9, 2006; the disclosure of which is incorporated herein by reference in its entirety.

### TECHNICAL FIELD

The subject matter described herein relates to selectively identifying circular routes in a network. More particularly, the subject matter described herein relates to methods, systems and computer program products for individually identifying and disabling circular routes from a plurality of active routes to a common destination.

### BACKGROUND ART

Circular routes in signaling networks are caused by misconfigured route tables in nodes that route signaling messages. For example, if node A has a route to node C through a signaling link connected to node B, and the route table node B is misconfigured to indicate that node C is reachable through node A, messages from node A to node C that go through node B could be circularly routed between node A and node B.

In networks that use SS7 routing procedures to route signaling messages, circular routes can lead to congestion on SS7 signaling links. For example, because circularly routed messages never reach a destination for processing, the transmit queues associated with signaling links that receive circularly routed messages can become full with the circularly routed messages. Once a transmit queue reaches a certain threshold queue depth, the node may indicate that the associated signaling link is under congestion. In response to detecting the congestion, the node may attempt to determine the cause of the congestion.

One conventional procedure for identifying the cause of such congestion includes generating a circular route test (CRT) message addressed to a destination point code (DPC) for which circular routing is suspected. The originating point code in the message may be set to the point code of the signal transfer point (STP) performing the testing. Because conventional SS7 routing is based on DPC only, no additional routing parameters associated with circularly routed traffic are included in the CRT message. Once generated, the CRT message is routed based on its DPC to the corresponding destination. If the STP that sends the CRT message receives the CRT message within a timeout period, a circular route is indicated, and the STP disables the route corresponding to the DPC.

Disabling the route corresponding to the DPC is an acceptable solution to preventing of circular routing where only a single DPC-only route exists for the destination. However, if a route table contains multiple routes that include the DPC as a routing parameter or key, routes that do not cause circular routing will be unnecessarily disabled.

Another problem associated with using the conventional circular route test procedure described above is that because the CRT message uses only the DPC from circularly routed traffic, circular routing may not be detected if it is caused by routes based on parameters other than the DPC. For example, it may be desirable to provision a route table with routes based on DPC and SI or DPC and CIC. If the DPC plus SI route is misconfigured somewhere in the network, a CRT message with the DPC and not the SI will fail to identify the circular route.

Accordingly, in light of these difficulties associated with conventional methods for identifying circular routing, the subject matter described herein includes methods, systems and computer program products for individually identifying and disabling circular routes from a plurality of active routes to a common destination.

### SUMMARY

According to one aspect, the subject matter described herein includes a method for individually identifying and disabling circular routes from a plurality of active routes to a common destination. The method includes maintaining the plurality of active routes to a common destination. Congestion is detected on a signaling link associated with one of the routes. At least one of the routes is tested for circularity. At least one of the routes is identified as circular based on the testing. In response to identifying a circular route, the circular route is disabled. Use of the remaining active routes to the destination is continued.

The subject matter described herein for individually identifying circular routes can be implemented using a computer program product comprising computer executable instructions embodied in a computer readable medium. Exemplary computer readable media suitable for implementing the subject matter described herein include chip memory devices, disk memory devices, application specific integrated circuits, programmable logic devices and downloadable electrical signals. In addition, a computer program product that implements the subject matter described herein to be located on a single device or computer platform or may be distributed against multiple devices or computing platforms.

### BRIEF DESCRIPTION OF THE DRAWINGS

Preferred embodiments of the subject matter described herein will now be explained with reference to the accompanying drawings of which:

FIG. 1 is a flow chart illustrating exemplary steps for using multiple routes to a common destination and for individually identifying and disabling circular routes from the active routes to a destination according to an embodiment of the subject matter described herein;

FIG. 2 is a network diagram illustrating a signal transfer point capable of individually identifying and disabling circular routes from a plurality of routes to a common destination according to an embodiment of this subject matter described herein;

FIG. 3 is a flow chart illustrating exemplary detailed steps for individually identifying circular routes from a plurality of active routes to a destination according to embodiment of the subject matter described herein; and

FIG. 4 is a block diagram illustrating an exemplary architecture for a signal transfer point capable of individually identifying and disabling circular routes from a plurality of active routes to a common destination according to an embodiment of the subject matter described herein.

### DETAILED DESCRIPTION OF THE INVENTION

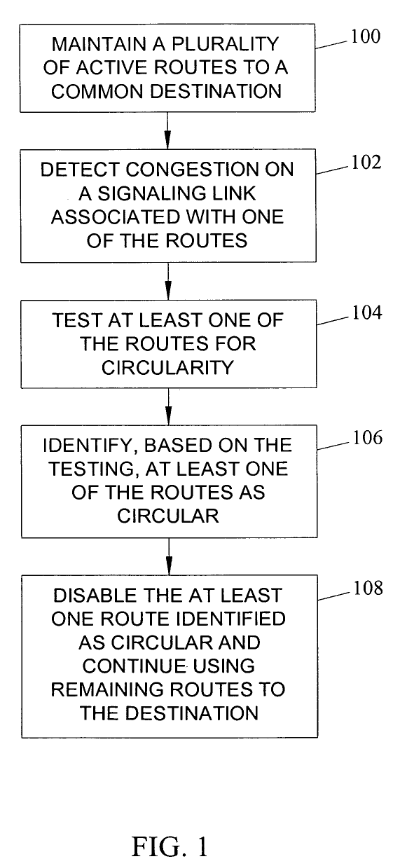

The subject matter described herein includes methods for individually identifying and disabling circular routes from a plurality of active routes to a common destination. FIG. 1 is a flow chart illustrating exemplary overall steps for individually identifying and disabling circular routes from a plurality of routes to a common destination according to the embodiment of the subject matter described herein. Referring to FIG. 1, in step 100, a plurality of active routes to a destination is maintained. Step 100 may be performed by a signal transfer point that maintains multiple routes keyed by different parameters, referred to as routing keys, to a common destination. For example, the signal transfer point may include one route that is keyed by a particular originating point code (OPC) value and a particular destination point code (DPC) value. The signal transfer point may maintain another route to the same destination that is keyed by a different OPC value. Yet another route to the same destination may be keyed by a service indicator (SI) value in addition to the DPC value. Yet another route may be keyed by a circuit identification code (CIC) and the DPC. The routes may be arranged in a predetermined hierarchy such that the highest-level route that matches the routing parameters in a received message is used to route the message. The routes may share a DPC and may have a common destination. However, as will be described in more detail below, at least some of the routes may correspond to different paths to the destination, some of which may contain circular routes and others of which may not. The present subject matter provides a method for individually identifying and disabling the circular routes to a destination while continuing to use the remaining active routes.

An exemplary method for maintaining and using multiple active routes to a common destination and for setting congestion levels on the active routes is described in a commonly assigned, co-pending U.S. patent application entitled, “Methods, Systems, and Computer Program Products for Setting Congestion Levels for Plurality of Routes to a Common Destination,” filed on Apr. 28, 2006 (serial no. not yet assigned), the disclosure of which is incorporated herein by reference in its entirety. Briefly, this application discloses a method where congestion levels are set for a primary route and multiple exception routes to a destination. The primary route and the exception routes are keyed by different parameters or routing keys. The routes may be selected in a predetermined hierarchy such that the route to a destination is selected to be the highest-level route in the hierarchy that matches the routing parameters in a message. Such routes may be used by embodiments of the subject matter described herein to selectively route messages over one of a plurality of routes to a destination based on multi- or single-parameter routing keys in each message.

Returning to FIG. 1, in step 102, congestion is detected on a signaling link associated with one of the routes. Congestion may be detected based on the depth of a transmit queue associated with the signaling link exceeding a threshold value. In step 104, at least one of the routes is tested for circularity. As will be described in further detail below, in order to test one of the routes, a circular route test message may be formulated based on traffic in the transmit queue associated with the link that experienced the congestion and routed over the network. If the circular route test message arrives back at the sender within a predetermined time period, circularity is detected. In step 106, at least one of the routes is identified as circular based on the testing. As stated, a route may be identified as circular if the circular route test message arrives back at the sender within a time period. In step 108, the route that is identified as circular is disabled, and use of the remaining routes to the destination is continued. Thus, even though a single route to a destination is identified as circular, remaining routes to the destination may be continued, even when the routes share one or more routing keys in common with the disabled route.

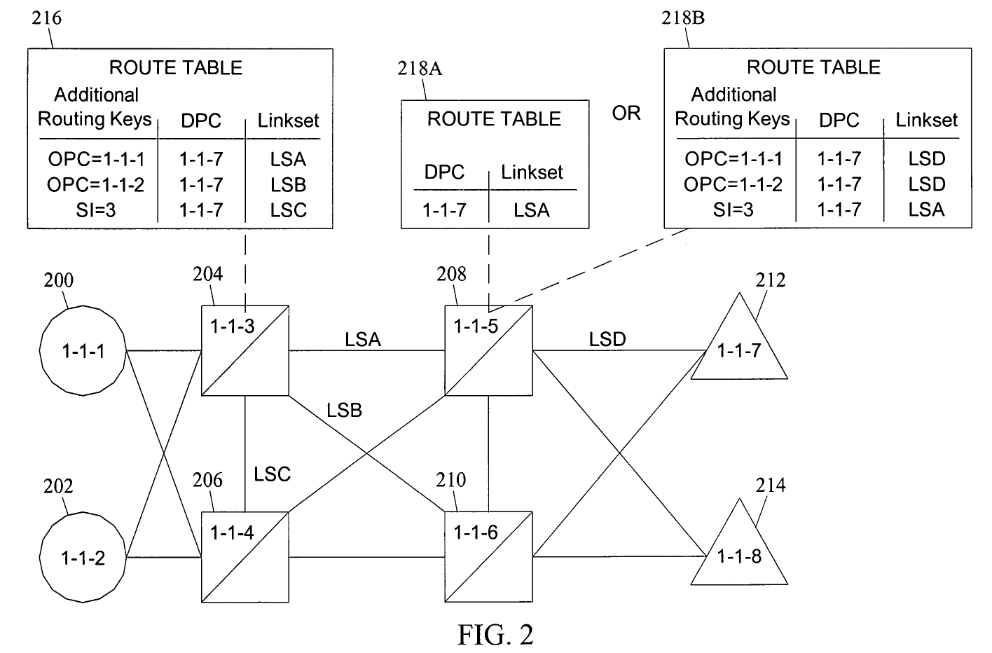

FIG. 2 is a network diagram illustrating exemplary network components including a signal transfer point for individually identifying and disabling active routes from plural active routes to a common destination according to an embodiment of the subject matter described herein. Referring to FIG. 2, the network includes service switching points (SSPs) 200 and 202, signal transfer points (STPs) 204, 206, 208, and 210, and service control points (SCPs) 212 and 214. Service switching points 200 and 202 are end office switches for performing signaling and making media connections between subscribers. Signal transfer points 204, 206, 208, and 210 are nodes that route signaling messages using SS7 routing protocols. In this example, it is assumed that signal transfer point 204 includes the capability for individually identifying and disabling circular routes from a plurality of active routes to a common destination according to the embodiment of the subject matter described herein. Service control points 212 and 214 may include one or more databases used by service switching points 200 and 202 to control call processing. For example, SCPs 212 and 214 may contain number portability databases, calling name databases, or other suitable databases associated with call processing.

In the illustrated example, each node is assigned a point code indicated by the numbers inside each node. For example, SSP 200 is assigned a point code of 1-1-1, SSP 202 is assigned a point code 1-1-2, STP 204 is assigned a point code of 1-1-3, STP 206 is assigned a point code of 1-1-4, SCP 212 is assigned a point code of 1-1-7, and SCP 214 is assigned a point code of 1-1-8. Each line that joins the nodes in FIG. 2 indicates a signaling linkset. In SS7 networks, a signaling linkset is a group of signaling links that interconnect two nodes. In FIG. 2, some of the signaling linksets have been labeled for illustrative purposes. For example, linkset LSA connects STPs 204 and 208, linkset LSB connects STPs 204 and 210. Linkset LSC connects STPs 204 and 206, and linkset LSD connects STP 208 and SCP 212.

In the illustrated example, a route table 216 that may be maintained by STP 204 is shown. In a first example, a routing table 218A may be maintained by STP 208. Another routing table 218B that may be maintained by STP 208 will be described in a second example below to illustrate functionality of the subject matter described herein. In the first example, route table 216 includes multiple routes to the destination 1-1-7, which corresponds to SCP 212. Each route is keyed by a different combination of routing keys. For example, the first route to the destination is keyed by OPC=1-1-1 and DPC=1-1-7. This route corresponds to linkset LSA. The second route to the destination is keyed by OPC=1-1-2 and DPC=1-1-7. This route corresponds to linkset LSB. The third route to the destination corresponds to SI=3 and DPC=1-1-7. This route corresponds to linkset LSC. Accordingly, depending on the OPC, the DPC, and the SI, different active routes to the destination 1-1-7 may be selected.

In the first example where STP 208 includes route table 218A, it can be seen that the route table contains a circular entry. That is, if a message from STP 204 with DPC 1-1-7 arrives at STP 208, the message will be routed over linkset LSA, which will send the message back to STP 204. The message will be circularly routed between STP 204 and 208 without ever reaching destination SCP 212. If multiple such messages are transmitted, the transmit queues associated with links in linkset LSA will indicate congestion. However, rather than disabling all of the routes to DPC 1-1-7 in route table 216, the subject matter described herein includes individually testing at least one route to the destination, determining whether circularity is present, disabling routes identified as circular, and continuing the remaining active routes to the destination.

In a second example, it is assumed that both STP 204 and 208 include multiple active routes to 1-1-7. However, one of the routes to the destination maintained by STP 208 is a circular route. The circular route is illustrated by the last entry in route table 218B where the routing keys SI=3 and DPC=1-1-7 corresponds to linkset LSA. Using conventional methods, if STP 204 identifies congestion on any links associated with linkset LSA, STP 204 may initiate circular route testing using the DPC 1-1-7. However, since the circular route is only triggered if the message includes SI=3, circularity may not be detected if the circular route test message does not include SI=3. Accordingly, as will be described in more detail below, STP 204 may formulate a circular route test message that mimics at least the routing keys of traffic in the transmit queue associated with the link under congestion. In one implementation, the circular route test message may mimic the routing keys and any additional parameters in signaling message traffic in a transmit queue corresponding to the link being tested.

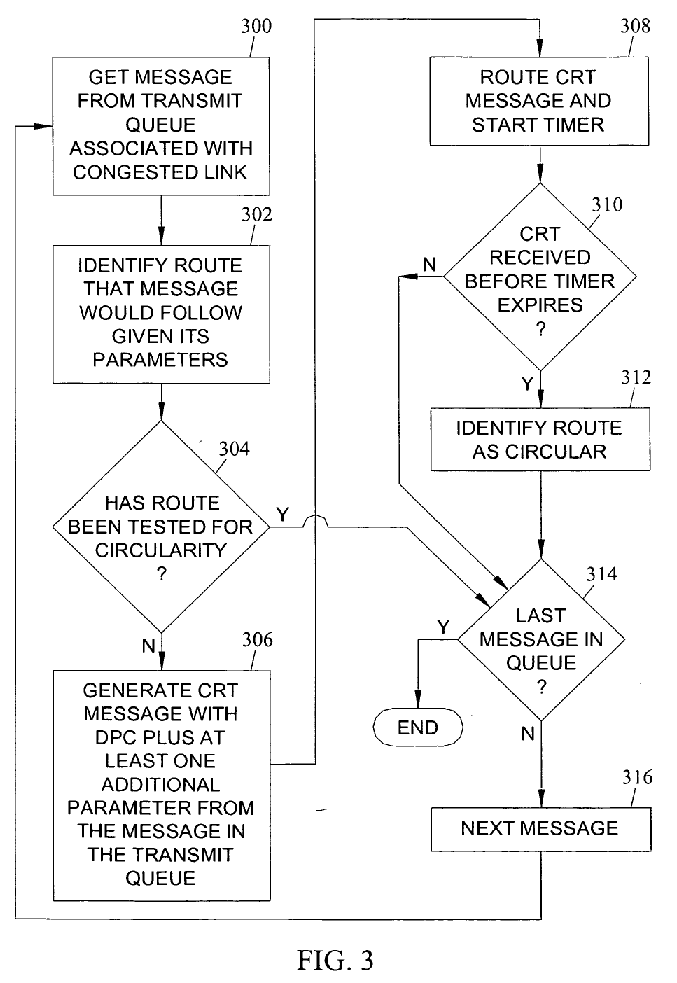

FIG. 3 is a flow chart illustrating exemplary detailed steps for individually identifying circular routes from a plurality of active routes to a common destination according to an embodiment of the subject matter described herein. Referring to FIG. 3, in step 300, the first message from the transmit queue associated with a congested link is examined. In step 302, the route that the message would follow given its parameters is determined. Using route table 216 illustrated in FIG. 2 as an example, if the message has OPC=1-1-1 and DPC=1-1-7, the first route in route table 216 would be identified. As stated above, the route that a message would follow may be the highest-level route in a hierarchy of routes that matches the routing keys in a message. In step 304, it is determined whether the route has been tested for circularity. If the route has not been tested for circularity, control proceeds to step 306 where circular route testing for the route begins.

In step 306, a CRT message is generated with the destination point code plus at least one additional parameter from the message in the transmit queue. As stated above, the parameters that may be included in the CRT message may correspond to the routing keys of the route over which the message would be routed. Using the example above, the CRT message would have at least DPC=1-1-7 and OPC=1-1-1. In order to further increase the likelihood that an individual circular route will be identified, additional parameters from the message in the transmit queue, such as SCCP parameters, TCAP parameters, MAP parameters, or ISUP parameters, may be included in the CRT message. In step 308, the CRT message is routed. Routing the message may include performing a lookup in the route table on the interface module or card that originates the CRT message and routing the CRT message over the appropriate outbound signaling link. A timer may be started when the message is routed.

If the circular route test message is an ISUP message, the message may have a reserved message type parameter and a payload identifying the message as a circular route test message. If the circular route test message is a network management message, the circular route test message may have a reserved h0h1 value and a payload identifying the message as a circular route test message. If the message is an SCCP message, the message may have a reserved message type and a payload identifying the message as a circular route test message.

In step 310, it is determined whether a CRT message is received before the timer expires. Since the sender of the CRT message may include multiple interface modules, step 310 may be performed by informing each of the interface modules of the circular route testing being performed so that any of the signaling link interface modules that receive the CRT message will inform the sending module. If the CRT message is received before the timer expires, control proceeds to step 312 where the route is identified as circular.

Returning to step 304, if the route identified from the message parameters has already been tested, i.e., because another message with identical parameters has been tested within a predetermined time interval, control proceeds to step 314 where it is determined whether the message is the last message in the transmit queue associated with the congested link. Similarly, in step 312, once testing of the first message is completed, control proceeds to step 314 where it is determined whether that message is the last message in the transmit queue. In either case, if the message is not the last message in the transmit queue, control proceeds to step 316 where the next message is identified. Steps 300-314 are then repeated to test the next message and determine whether the route that it followed is circular. In step 314, if the current message being tested is the last message, circular route testing ends.

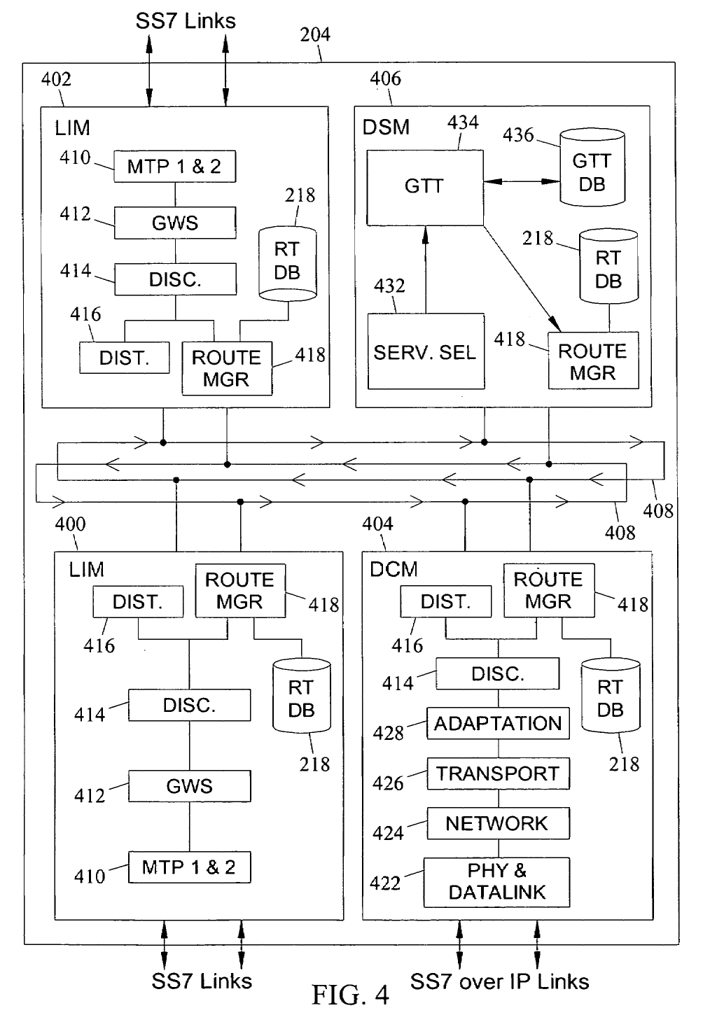

Although in the example illustrated in FIG. 4, each message in the transmit queue associated with a congested signaling link is used as a candidate for circular route testing, the subject matter described herein is not limited to using each message in the transmit queue as a candidate. In an alternate embodiment, messages in the transmit queue may be grouped according to routing keys. A threshold value may be set. If a number of messages received for a given group within a time interval exceeds the threshold, a CRT message may be generated for the group. Groups of messages for which the number of messages received within a time interval does not exceed the threshold may be excluded from circular route testing.

FIG. 4 is a block diagram illustrating an exemplary signal transfer point including a route manager for individually identifying and disabling circular routes from plural active routes to a common destination according to an embodiment of the subject matter described herein. Referring to FIG. 4, signal transfer point 204 includes a plurality of modules 400, 402, 404, 406, and 408 connected via a bus 408. Each module may include hardware, software and firmware for performing functions relating to routing signaling messages. In one implementation, each module may include an application processor for executing routing, database, and other communications applications. Each module may further include a communication processor for transferring messages over a bus 408. In the illustrated example, modules 400 and 402 are link interface modules (LIMs) including functionality for routing SS7 messages over SS7 signaling links. Each link interface module includes an SS7 message transfer part level one and two function 410, a gateway screening function 412, a discrimination function 414, a distribution function 416, a route manager 418, and a route database 420. MTP level one and two function 410 performs SS7 MTP level one and two operations, such as error detection, error correction, and sequencing of SS7 signaling messages. Gateway screening function 412 may screen SS7 signaling messages based on one or more parameters in the signaling messages to determine whether to allow the messages into a network. Discrimination function 414 determines whether received messages are to be routed or whether the messages require internal processing by STP 204. Such a determination may be made based on the DPC and additional parameters in the signaling messages. For messages requiring internal processing, discrimination function 414 forwards these messages to distribution function 416. Distribution function 416 then forwards the messages to the appropriate internal processing module for further processing.

For messages that require routing, discrimination function 414 forwards these messages to route manager 418. Route manager 418 performs a lookup in route database 218 based on the DPC and any additional routing keys in the message that are present in route database 218. Route database 218 may maintain a plurality of active routes to a common destination as illustrated in FIG. 2. Route manager 418 may perform the functions described herein for individually testing and disabling circular routes among plural active routes to the common destination.

Although in the example illustrated in FIG. 2, the routing and circular route testing functions are performed by route manager 418, the subject matter described herein is not limited to having the same function perform route lookups and circular route detection and management. In an alternate implementation, a routing function may be responsible for performing route lookups and a separate congestion manager may perform congestion management and circular route testing. The term “route manager” as used herein is intended to generically refer to either implementation.

Communications module 404 comprises a data communications module (DCM) for sending and receiving SS7 signaling messages over IP signaling links. In the illustrated example, DCM 404 includes a physical and data link layer function 422, a network layer function 424, a transport layer function 426, annotation layer function 428, and functions 414, 416, and 418 as well as database 218 described with regard to limbs 400 and 402. Physical and data link layer function 420 may perform open systems interconnect (OSI) physical data link layer operations, such as transmitting signals over the underlying communication medium and performing medium access control. An example of a physical and data link layer function suitable for the subject matter described herein includes an Ethernet function. Network layer function 414 performs OSI network layer functions for sending and receiving messages over a network. In one example, network layer function 424 may implement Internet protocol (IP). Transport layer function 426 performs OSI transport layer functions, such as maintaining connections between endpoints. Examples of transport layer protocols that may be implemented by transport layer function 426 include TCP, UDP, and SCTP. Adaptation layer function 428 performs operations for sending and receiving SS7 messages over IP signaling links. Exemplary adaptation layer functions suitable for use with the subject matter described herein include any of the signaling transport (SIGTRAN) protocols, as described in Internet Engineering Task Force (IETF) requests for comments (RFCs) and internet drafts. Examples of specific SIGTRAN protocols that may be implemented include M2PA, M3UA, and SUA, as described in the correspondingly named IETF Internet drafts and RFCs.

Functions 414, 416, and 418 perform similar operations to their counterparts described above with regard to LIMs 400 and 402. Hence, a description thereof will not be repeated herein. Similarly, route database 218 may include multiple routes to a destination that are keyed by different combinations of routing keys.

Module 406 comprises a database services module (DSM) for providing database services for received signaling messages. In the illustrated example, DSM 406 includes a service selection function 432, a global title translation (GTT) function 434, a GTT database 436, route database 218, and route manager 418. Service selection function 432 receives signaling messages identified as requiring internal processing and selects appropriate processing service. GTT function 434 performs GTT lookups in GTT database 436. Performing a GTT lookup may include a performing a lookup based on a called party address parameter in the SCCP portion of a received signaling message. The result of the GTT lookup may be a point code and a subsystem number corresponding to an intermediate or final destination. This information may be inserted in a signaling message. The signaling message may be passed to route manager 418 where the message is routed to the LIM or DCM associated with the outbound signaling link using data obtained from route database 218.

In operation, when one of route managers 418 detects congestion on a signaling link, the route manager may initiate the circular route testing procedures described above with respect to FIG. 3. In order to avoid conflicts with two route managers performing circular route testing for the same routing key(s), the route manager that initiates circular route testing may inform the other route managers of the test being performed. If another route manager is attempting to initiate circular route testing for the same routing key(s), the testing may be awarded to one or the other route managers based on contention resolution criteria. For example, control of the testing may be awarded to the route manager with the signaling link having the lowest signaling link identifier within a linkset where signaling links are consecutively numbered.

If a route manager other than the initiating route manager receives from the network a circular route test message, the route manager may detect that the route is circular and may inform the route managers of the remaining link interface modules of STP 204 so that they can disable the corresponding routes in their respective route databases. Once a route is determined to be circular, that route is preferably disabled in all of routing databases 218. Thus, the steps described above may be implemented using a system, such as the STP illustrated in FIG. 4, where modules each include their own routing database.

The subject matter described herein for individually testing routes to a common destination for circularity may be performed based on any type of signaling message that uses SS7 message transfer part (MTP) routing to reach a common destination, regardless of the underlying transport medium for the signaling messages. For example, the subject matter described herein may be used to test routes for SS7 signaling messages transmitted over TDM-based signaling links using MTP levels 1 through 3 and SS7 over ATM-based signaling links. In addition, the subject matter described herein may be used to test routes for SS7 signaling messages that are sent over Internet protocol networks using any of the adaptation, transport, and network layers described above.

The subject matter described herein may also be used to test circular routes on any network domain type. The domain type of a network refers to the national network SS7 protocol variation used. Examples of different domain type include American National Standards Institute (ANSI), International Telecommunications Union International (ITU-I), or any national variation of the ITU protocol. For example, the circular route test procedures described herein may be used to test routes for messages that arrive from ANSI domains that are destined for ITU domains and vice versa.

It will be understood that various details of the invention may be changed without departing from the scope of the invention. Furthermore, the foregoing description is for the purpose of illustration only, and not for the purpose of limitation.

What is claimed is:

1. A method for individually identifying circular routes from a plurality of routes to a common destination, the method comprising:
(a) maintaining a plurality of active routes to a common destination;
(b) detecting congestion on a signaling link associated with at least one of the routes;
(c) in response to detecting the congestion, testing at least one of the routes for circularity;
(d) identifying, based on the testing, at least one of the routes as circular; and
(e) in response to identifying at least one of the routes as circular, disabling the at least one route identified as circular and continuing use of remaining active routes to the destination.

2. The method of the claim 1 wherein maintaining a plurality of active routes to a common destination includes maintaining a plurality of routes that use a common destination point code (DPC) as a routing key.

3. The method of claim 2 wherein maintaining a plurality of active routes includes maintaining at least one route keyed by an originating point code (OPC) and the DPC.

4. The method of claim 3 wherein maintaining a plurality of active routes to a common destination includes maintaining at least one route keyed by a circuit identification code (CIC) and the DPC.

5. The method of claim 4 wherein maintaining a plurality of active routes to a common destination includes maintaining at least one route keyed by a service indicator (SI) and the DPC.

6. The method of claim 1 wherein detecting congestion includes determining whether a depth for a transmit queue associated with the signaling link exceeds a congestion threshold.

7. The method of claim 6 wherein testing at least one of the routes includes:
(a) generating a circular route test message based on a message in the transmit queue;
(b) routing the circular route test message; and
(c) determining whether the circular route test message has been routed back to a sender within a timeout period.

8. The method of claim 7 wherein generating a circular route test message based on a message in the transmit queue includes generating a circular route test that includes routing keys present in the message in the transmit queue.

9. The method of claim 8 wherein generating a circular route test message includes generating a circular route test message that includes at least one parameter from the message in the transmit queue in addition to the routing keys.

10. The method of claim 7 wherein the circular route test message comprises an ISDN user part (ISUP) message having a reserved message type and a payload identifying the message as a circular route test message.

11. The method of claim 7 wherein the circular route test message comprises a network management message having a reserved h0h1 value and a payload identifying the message as a circular route test message.

12. The method of claim 7 wherein the circular route test message comprises a signaling connection control part (SCCP) message having a reserved message type and a payload identifying the message as a circular route test message.

13. The method of claim 1 wherein testing at least one of the routes includes testing a route for which a number of messages in a transmit queue associated with the signaling link exceeds a threshold.

14. The method of claim 1 wherein the signaling link comprises an SS7 over time-division multiplexed (TDM) signaling link.

15. The method of claim 1 wherein the signaling link comprises an SS7 over asynchronous transfer mode (ATM) signaling link.

16. The method of claim 1 wherein the signaling link comprises an SS7 over Internet protocol (IP) signaling link.

17. The method of claim 1 wherein testing at least one of the routes includes generating a circular route test message on a signaling link interface module associated with the signaling link and informing other signaling link interface modules of the initiation of the circular route testing.

18. The method of claim 1 wherein initiating circular route testing includes initiating circular route testing for a signaling message received from a first domain and destined for a second domain that is different from the first domain.

19. A system for individually identifying circular routes from a plurality of routes to a common destination, the system comprising:
(a) a route table for maintaining a plurality of active routes to a common destination; and
(b) a route manager for:
(i) detecting congestion on a signaling link associated with at least one of the routes;
(ii) in response to detecting the congestion, testing at least one of the routes for circularity;
(iii) identifying, based on the testing, at least one of the routes as circular; and
(iv) in response to identifying at least one of the routes as circular, disabling the at least one route identified as circular and allowing continued use of remaining active routes to the destination.

20. The system of claim 19 wherein the route table includes a plurality of routes that use a common destination point code (DPC) as a routing key.

21. The system of claim 20 wherein the route table includes at least one route keyed by an originating point code (OPC) and the DPC.

22. The system of claim 20 wherein the route table includes at least one route keyed by a circuit identification code (CIC) and the DPC.

23. The system of claim 20 wherein the route table includes a route keyed by a service indicator (SI) and the DPC.

24. The system of claim 19 wherein, in detecting the congestion, the route manager is adapted to determine whether a depth for a transmit queue associated with the signaling link exceeds a congestion threshold.

25. The system of claim 24 wherein the route manager, in testing at least one of the routes, is adapted to:
(a) generate a circular route test message based on a message in the transmit queue;
(b) route the circular route test message; and
(c) determine whether the circular route test message has been routed back to a sender within a timeout period.

26. The system of claim 25 wherein the circular route test message includes routing keys present in the message in the transmit queue.

27. The system of claim 26 wherein the circular route test message includes at least one parameter from the message in the transmit queue in addition to the routing keys.

28. The system of claim 25 wherein the circular route test message comprises an ISDN user part (ISUP) message having a reserved message type and a payload identifying the message as a circular route test message.

29. The system of claim 25 wherein the circular route test message comprises a network management message having a reserved h0h1 value and a payload identifying the message as a circular route test message.

30. The system of claim 25 wherein the circular route test message comprises a signaling connection control part (SCCP) message having a reserved message type and a payload identifying the message as a circular route test message.

31. The system of claim 19 wherein the route manager is adapted to test for circularity a route for which a number of messages in a transmit queue associated with the signaling link exceeds a threshold.

32. The system of claim 19 wherein the signaling link comprises an SS7 over time-division-multiplexed (TDM) signaling link.

33. The system of claim 19 wherein the signaling link comprises an SS7 over asynchronous transfer mode (ATM) signaling link.

34. The system of claim 19 wherein the signaling link comprises an SS7 over Internet protocol (IP) signaling link.

35. The system of claim 19 wherein the signaling message originates from a first domain of a first type and is destined for a second domain of a second type different from the first type.

36. A computer program product comprising computer executable instructions embodied in a computer readable medium for performing steps comprising:
(a) maintaining a plurality of active routes to a common destination;
(b) detecting congestion on a signaling link associated with at least one of the routes;
(c) in response to detecting the congestion, testing at least one of the routes for circularity;
(d) identifying, based on the testing, at least one of the routes as circular; and
(e) in response to identifying at least one of the routes as circular, disabling the at least one route identified as circular and continuing use of remaining active routes to the destination.

37. The computer program product of claim 36 wherein maintaining a plurality of active routes to a common destination includes maintaining a plurality of routes that use a common destination point code (DPC) as a routing key.

38. The computer program product of claim 37 wherein maintaining a plurality of active routes includes maintaining at least one route keyed by an originating point code (OPC) and the DPC.

39. The computer program product of claim 37 wherein maintaining a plurality of active routes to a common destination includes maintaining at least one route keyed by a circuit identification code (CIC) and the DPC.

40. The computer program product of claim 37 wherein maintaining a plurality of active routes to a common destination includes maintaining at least one route keyed by a service indicator (SI) and the DPC.

41. The computer program product of claim 36 wherein detecting congestion includes determining whether a depth for a transmit queue associated with the signaling link exceeds a congestion threshold.

42. The computer program product of claim 36 wherein testing at least one of the routes includes:
(a) generating a circular route test message based on a message in the transmit queue;
(b) routing the circular route test message; and
(c) determining whether the circular route test message has been routed back to a sender within a timeout period.

43. The computer program product of claim 42 wherein generating a circular route test message based on a message in the transmit queue includes generating a circular route test message that includes routing keys present in the message in the transmit queue.

44. The computer program product of claim 43 wherein generating a circular route test message includes generating a circular route test message that includes at least one parameter from the message in the transmit queue in addition to the routing keys.

45. The computer program product of claim 42 wherein the circular route test message comprises an ISDN user part (ISUP) message having a reserved message type and a payload identifying the message as a circular route test message.

46. The computer program product of claim 42 wherein the circular route test message comprises a network management message having a reserved h0h1 value and a payload identifying the message as a circular route test message.

47. The computer program product of claim 42 wherein the circular route test message comprises a signaling connection control part (SCCP) message having a reserved message type and a payload identifying the message as a circular route test message.

48. The computer program product of claim 36 wherein testing at least one of the routes includes testing a route for which a number of messages in a transmit queue associated with the signaling link exceeds a threshold.

49. The computer program product of claim 36 wherein the signaling link comprises an SS7 over time-division multiplexed (TDM) signaling link.

50. The computer program product of claim 36 wherein the signaling link comprises an SS7 over asynchronous transfer mode (ATM) signaling link.

51. The computer program product of claim 36 wherein the signaling link comprises an SS7 over Internet protocol (IP) signaling link.
